(19) United States
(12) Patent Application Publication
(10) Pub. No.: US 2025/0150796 A1
(43) Pub. Date: May 8, 2025

(54) METHOD AND DEVICE FOR GENERATING MEASUREMENT OF VANISHING SENSOR IN M2M SYSTEM

(71) Applicants: Hyundai Motor Company, Seoul (KR); Kia Corporation, Seoul (KR); Industry Academy Cooperation Foundation of Sejong University, Seoul (KR)

(72) Inventor: Jae Seung Song, Seoul (KR)

(21) Appl. No.: 18/836,738

(22) PCT Filed: Dec. 20, 2022
(86) PCT No.: PCT/KR2022/020773

§ 371 Date: Aug. 7, 2024

Related U.S. Application Data
(60) Provisional application No. 63/307,836, filed on Feb. 8, 2022.

(51) Int. Cl. H04W 4/70; H04W 84/18

(52) U.S. Cl. CPC H04W 4/70; H04W 84/18

(57) ABSTRACT

In a machine-to-machine (M2M) system, a method for generating a measurement of a vanishing sensor may include steps of: receiving at least one of a first measurement of the vanishing sensor or a second measurement of a reference sensor, determining whether or not the vanishing sensor has vanished, generating a third measurement based on the second measurement in case the vanishing sensor is determined to have vanished, and storing the third measurement as a measurement of the vanishing sensor that has vanished. An apparatus for generating the measurement of the vanishing sensor in the M2M system includes a transceiver and a processor, where the processor is configured to perform the above steps.

### CROSS-REFERENCE TO RELATED APPLICATIONS

The present application is a U.S. National Phase application under 35 U.S.C. § 371 of International Application No. PCT/KR2022/020773 filed on Dec. 20, 2022, which claims under 35 U.S.C. § 119 (e) the benefit of U.S. Provisional Application Ser. No. 63/307,836 filed on Feb. 8, 2022, the entire contents of which are incorporated by reference herein.

### BACKGROUND

### (a) Technical Field

The present disclosure relates to a machine-to-machine (M2M) system, and more particularly, to a method and apparatus for generating a measurement of a vanishing sensor in an M2M system.

### (b) Description of the Related Art

Recently, Machine-to-Machine (M2M) systems have been introduced in different applications. An M2M communication may refer to a communication performed between machines without human intervention. M2M includes Machine Type Communication (MTC), Internet of Things (IoT) or Device-to-Device (D2D). In the following description, the term “M2M” is uniformly used for convenience of explanation, but the present disclosure is not limited thereto. A terminal used for M2M communication may be an M2M terminal or an M2M device. An M2M terminal may generally be a device having low mobility while transmitting a small amount of data. Herein, the M2M terminal may be used in connection with an M2M server that centrally stores and manages inter-machine communication information. In addition, an M2M terminal may be applied to various systems such as object tracking, automobile linkage, and power metering.

Meanwhile, with respect to an M2M terminal, the oneM2M standardization organization provides requirements for M2M communication, things to things communication and IoT technology, and technologies for architecture, Application Program Interface (API) specifications, security solutions and interoperability. The specifications of the oneM2M standardization organization provide a framework to support a variety of applications and services such as smart cities, smart grids, connected cars, home automation, security and health.

### SUMMARY

The present disclosure is directed to providing a method and apparatus for generating a measurement of a vanishing sensor in a machine-to-machine (M2M) system.

The present disclosure is directed to providing a method and apparatus for managing a vanishing sensor in an M2M system.

The present disclosure is directed to providing a method and apparatus for generating a measurement of a vanishing sensor that has vanished, by using a reference sensor in an M2M system.

The technical problems solved by the present disclosure are not limited to the above technical problems and other technical problems which are not described herein will be clearly understood by a person having ordinary skill in the technical field, to which the present disclosure belongs, from the following description.

According to an embodiment of the present disclosure, a method for operating a device managing a sensor in a machine-to-machine (M2M) system may include receiving at least one of a first measurement of a vanishing sensor or a second measurement of a reference sensor, determining whether or not the vanishing sensor has vanished, generating a third measurement based on the second measurement in case the vanishing sensor is determined to have vanished, and storing the third measurement as a measurement of the vanishing sensor that has vanished.

According to an embodiment of the present disclosure, a device for managing a sensor in a machine-to-machine (M2M) system may include a transceiver and a processor coupled with the transceiver, and the processor may be configured to receive at least one of a first measurement of a vanishing sensor or a second measurement of a reference sensor, to determine whether or not the vanishing sensor has vanished, to generate a third measurement based on the second measurement in case the vanishing sensor is determined to have vanished, and to store the third measurement as a measurement of the vanishing sensor that has vanished.

According to the present disclosure, a measurement of a vanishing sensor may be generated in a machine-to-machine (M2M) system.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 illustrates a layered structure of a machine-to-machine (M2M) system according to the present disclosure.

FIG. 2 illustrates a reference point in an M2M system according to the present disclosure.

FIG. 3 illustrates each node in an M2M system according to the present disclosure.

FIG. 4 illustrates a common service function in an M2M system according to the present disclosure.

FIG. 5 illustrates a method in which an originator and a receiver exchange a message in an M2M system according to the present disclosure.

FIG. 6 illustrates a measurement mechanism of a vanishing sensor in an M2M system according to an embodiment of the present disclosure.

FIG. 7 illustrates an example of a procedure for acquiring sensor information in an M2M system according to an embodiment of the present disclosure.

FIG. 8 illustrates a resource of a vanishing sensor in an M2M system according to an embodiment of the present disclosure.

FIG. 9 illustrates an example of a procedure for generating a measurement of a vanishing sensor in an M2M system according to an embodiment of the present disclosure.

FIG. 10 illustrates an example of a procedure for generating a measurement of a vanishing sensor in an M2M system according to the present disclosure.

FIG. 11 illustrates a configuration of an M2M device in an M2M system according to the present disclosure.

### DETAILED DESCRIPTION

Hereinafter, embodiments of the present disclosure will be described in detail with reference to the accompanying drawings, which will be easily implemented by those skilled in the art. However, the present disclosure may be embodied in many different forms and is not limited to the exemplary embodiments described herein.

In the present disclosure, the terms first, second, etc. are used only for the purpose of distinguishing one component from another, and do not limit the order or importance of components, etc. unless specifically stated otherwise. Thus, within the scope of this disclosure, a first component in one embodiment may be referred to as a second component in another embodiment, and similarly a second component in one embodiment may be referred to as a first component.

In the present disclosure, when a component is referred to as being “linked”, “coupled”, or “connected” to another component, it is understood that not only a direct connection relationship but also an indirect connection relationship through an intermediate component may also be included. Also, when a component is referred to as “comprising” or “having” another component, it may mean further inclusion of another component not the exclusion thereof, unless explicitly described to the contrary.

In the present disclosure, components that are distinguished from each other are intended to clearly illustrate each feature. However, it does not necessarily mean that the components are separate. In other words, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. Also, exemplary embodiments that include other components in addition to the components described in the various exemplary embodiments are also included in the scope of the present disclosure.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

In addition, the present specification describes a network based on Machine-to-Machine (M2M) communication, and a work in M2M communication network may be performed in a process of network control and data transmission in a system managing the communication network. In the present specification, an M2M terminal may be a terminal performing M2M communication. However, in consideration of backward compatibility, it may be a terminal operating in a wireless communication system. In other words, an M2M terminal may refer to a terminal operating based on M2M communication network but is not limited thereto. An M2M terminal may operate based on another wireless communication network and is not limited to the exemplary embodiment described above.

In addition, an M2M terminal may be fixed or have mobility. An M2M server refers to a server for M2M communication and may be a fixed station or a mobile station. In the present specification, an entity may refer to hardware like M2M device, M2M gateway and M2M server. In addition, for example, an entity may be used to refer to software configuration in a layered structure of M2M system and is not limited to the embodiment described above.

In addition, for example, the present disclosure mainly describes an M2M system but is not solely applied thereto. In addition, an M2M server may be a server that performs communication with an M2M terminal or another M2M server. In addition, an M2M gateway may be a connection point between an M2M terminal and an M2M server. For example, when an M2M terminal and an M2M server have different networks, the M2M terminal and the M2M server may be connected to each other through an M2M gateway. Herein, for example, both an M2M gateway and an M2M server may be M2M terminals and are not limited to the embodiment described above.

The present disclosure relates to a method and device for generating a measurement of a vanishing sensor in an M2M system. Specifically, the present disclosure describes a technology of calculating a measurement of a vanishing sensor by using a measurement of a reference sensor after the vanishing sensor vanishes in an M2M system.

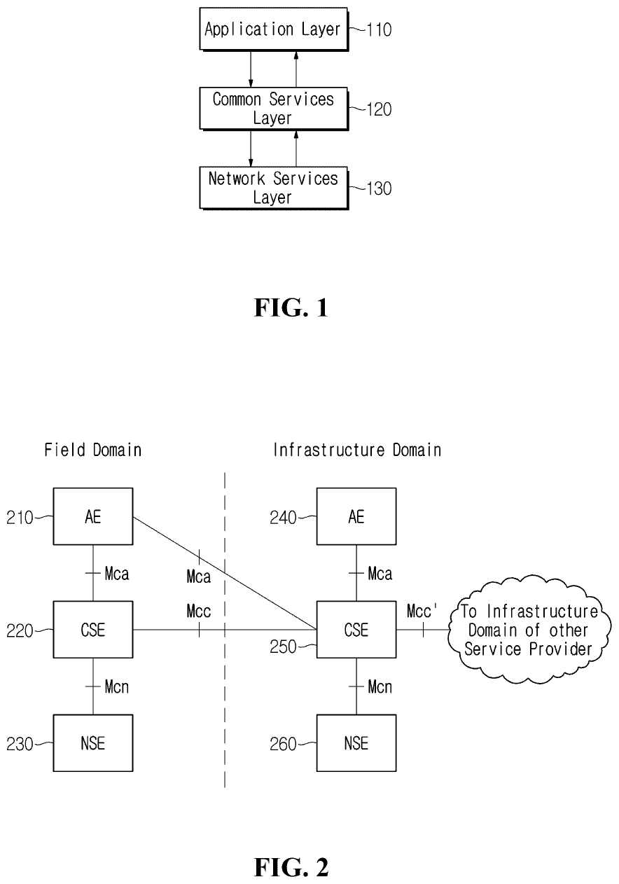

oneM2M is a de facto standards organization that was founded to develop a communal IoT service platform sharing and integrating application service infrastructure (platform) environments beyond fragmented service platform development structures limited to separate industries like energy, transportation, national defense and public service. oneM2M aims to render requirements for things to things communication and IoT technology, architectures, Application Program Interface (API) specifications, security solutions and interoperability. For example, the specifications of oneM2M provide a framework to support a variety of applications and services such as smart cities, smart grids, connected cars, home automation, security and health. In this regard, oneM2M has developed a set of standards defining a single horizontal platform for data exchange and sharing among all the applications. Applications across different industrial sections may also be considered by oneM2M. Like an operating system, oneM2M provides a framework connecting different technologies, thereby creating distributed software layers facilitating unification. Distributed software layers are implemented in a common services layer between M2M applications and communication Hardware/Software (HW/SW) rendering data transmission. For example, a common services layer may be a part of a layered structure illustrated in FIG. 1.

FIG. 1 is a view illustrating a layered structure of a Machine-to-Machine (M2M) system according to the present disclosure. Referring to FIG. 1, a layered structure of an M2M system may include an application layer 110, a common services layer 120 and a network services layer 130. Herein, the application layer 110 may be a layer operating based on a specific application. For example, an application may be a fleet tracking application, a remote blood sugar monitoring application, a power metering application or a controlling application. In other words, an application layer may be a layer for a specific application. Herein, an entity operating based on an application layer may be an application entity (AE).

The common services layer 120 may be a layer for a common service function (CSF). For example, the common services layer 120 may be a layer for providing common services like data management, device management, M2M service subscription management and location service. For example, an entity operating based on the common services layer 120 may be a common service entity (CSE).

The common services layer 120 may provide a set of services that are grouped into CSFs according to functions. A multiplicity of instantiated CSFs constitutes CSEs. CSEs may interface with applications (for example, application entities or AEs in the terminology of oneM2M), other CSEs and base networks (for example, network service entities or NSEs in the terminology of oneM2M). The network services layer 130 may provide the common services layer 120 with services such as device management, location service and device triggering. Herein, an entity operating based on the network layer 120 may be a network service entity (NSE).

FIG. 2 is a view illustrating reference points in an M2M system according to the present disclosure. Referring to FIG. 2, an M2M system structure may be distinguished into a field domain and an infrastructure domain. Herein, in each domain, each of the entities may perform communication through a reference point (for example, Mca or Mcc). For example, a reference point may indicate a communication flow between each entity. In particular, referring to FIG. 2, the reference point Mca between AE 210 or 240 and CSE 220 or 250, the reference point Mcc between different CSEs and Men reference point between CSE 220 or 250 and NSE 230 or 260 may be set.

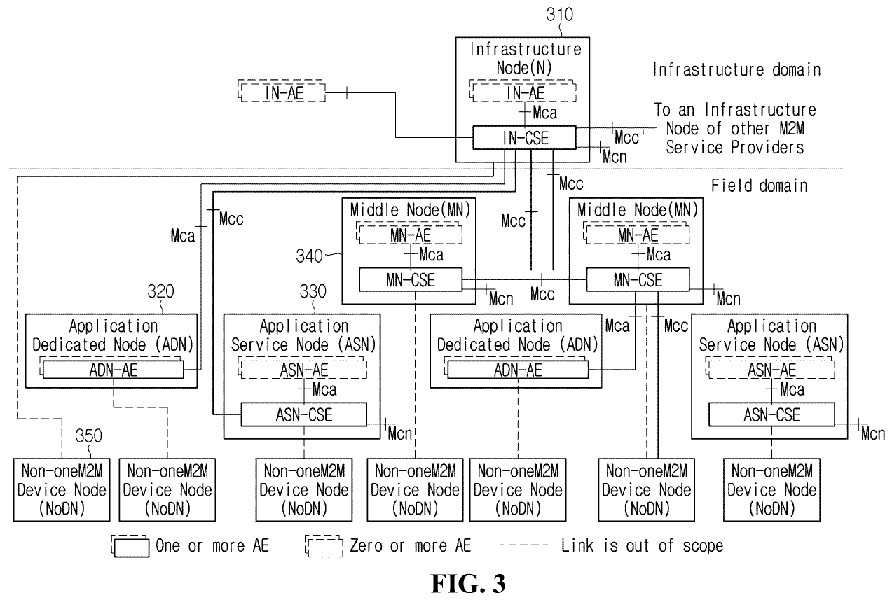

FIG. 3 is a view illustrating each node in an M2M system according to the present disclosure. Referring to FIG. 3, an infrastructure domain of a specific M2M service provider may provide a specific infrastructure node (IN) 310. Herein, the CSE of the IN may be configured to perform communication based on the AE and the reference point Mca of another infrastructure node. In particular, one IN may be set for each M2M service provider. In other words, the IN may be a node that performs communication with the M2M terminal of another infrastructure based on an infrastructure structure. In addition, for example, conceptually, a node may be a logical entity or a software configuration.

Next, an application dedicated node (ADN) 320 may be a node including at least one AE but not CSE. In particular, an ADN may be set in the field domain. In other words, an ADN may be a dedicated node for AE. For example, an ADN may be a node that is set in an M2M terminal in hardware. In addition, the application service node (ASN) 330 may be a node including one CSE and at least one AE. ASN may be set in the field domain. In other words, it may be a node including AE and CSE. In particular, an ASN may be a node connected to an IN. For example, an ASN may be a node that is set in an M2M terminal in hardware.

In addition, a middle node (MN) 340 may be a node including a CSE and including zero or more AEs. In particular, the MN may be set in the field domain. An MN may be connected to another MN or IN based on a reference point. In addition, for example, an MN may be set in an M2M gateway in hardware. As an example, a non-M2M terminal node 350 (Non-M2M device node, NoDN) is a node that does not include M2M entities. It may be a node that performs management or collaboration together with an M2M system.

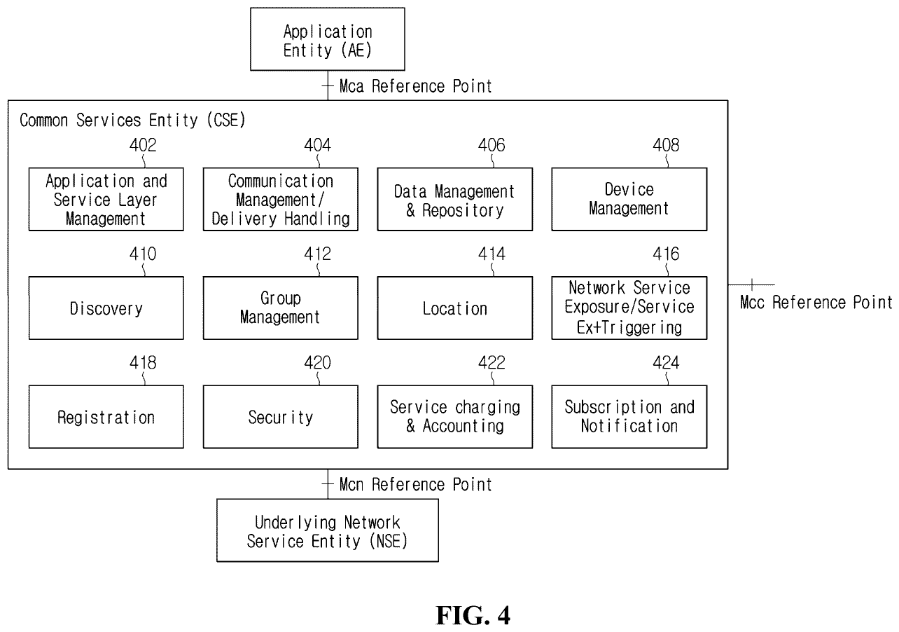

FIG. 4 is a view illustrating a common service function in an M2M system according to the present disclosure. Referring to FIG. 4, common service functions may be provided. For example, a common service entity may provide at least one or more CSFs among application and service layer management 402, communication management and delivery handling 404, data management and repository 406, device management 408, discovery 410, group management 412, location 414, network service exposure/service execution and triggering 416, registration 418, security 420, service charging and accounting 422, service session management and subscription/notification 424. At this time, M2M terminals may operate based on a common service function. In addition, a common service function may be possible in other embodiments and is not limited to the above-described exemplary embodiment.

The application and service layer management 402 CSF provides management of AEs and CSEs. The application and service layer management 402 CSF includes not only the configuring, problem solving and upgrading of CSE functions but also the capability of upgrading AEs. The communication management and delivery handling 404 CSF provides communications with other CSEs, AEs and NSEs. The communication management and delivery handling 404 CSF are configured to determine at what time and through what connection communications are to be delivered, and also determine to buffer communication requests to deliver the communications later, if necessary and permitted.

The data management and repository 406 CSF provides data storage and transmission functions (for example, data collection for aggregation, data reformatting, and data storage for analysis and sematic processing). The device management 408 CSF provides the management of device capabilities in M2M gateways and M2M devices.

The discovery 410 CSF is configured to provide an information retrieval function for applications and services based on filter criteria. The group management 412 CSF provides processing of group-related requests. The group management 412 CSF enables an M2M system to support bulk operations for many devices and applications. The location 414 CSF is configured to enable AEs to obtain geographical location information.

The network service exposure/service execution and triggering 416 CSF manages communications with base networks for access to network service functions. The registration 418 CSF is configured to provide AEs (or other remote CSEs) to a CSE. The registration 418 CSF allows AEs (or remote CSE) to use services of CSE. The security 420 CSF is configured to provide a service layer with security functions like access control including identification, authentication and permission. The service charging and accounting 422 CSF is configured to provide charging functions for a service layer. The subscription/notification 424 CSF is configured to allow subscription to an event and notifying the occurrence of the event.

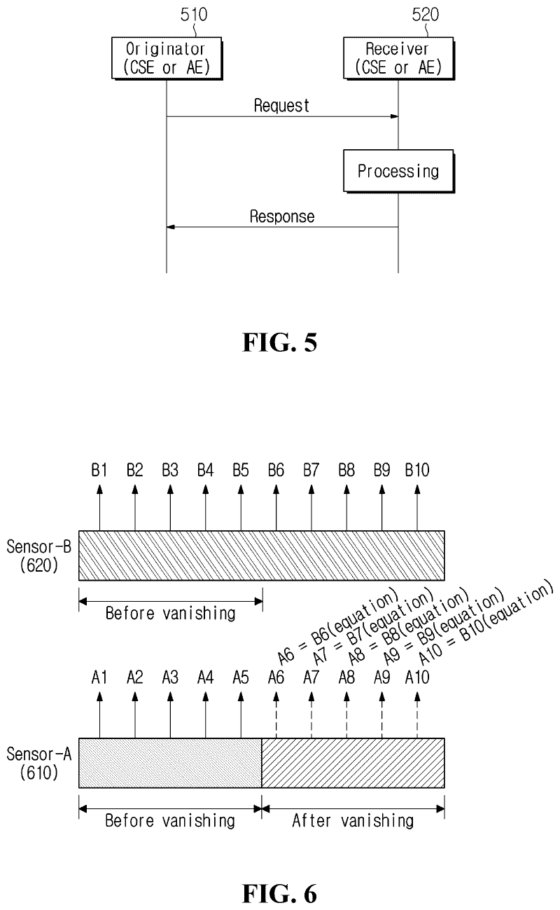

FIG. 5 is a view illustrating that an originator and a receiver exchange a message in an M2M system according to the present disclosure. Referring to FIG. 5, the originator 501 may be configured to transmit a request message to the receiver 520. In particular, the originator 510 and the receiver 520 may be the above-described M2M terminals. However, the originator 510 and the receiver 520 are not limited to M2M terminals but may be other terminals. They are not limited to the above-described exemplary embodiment. In addition, for example, the originator 510 and the receiver 520 may be nodes, entities, servers or gateways, which are described above. In other words, the originator 510 and the receiver 520 may be hardware or software configurations and are not limited to the above-described embodiment.

Herein, for example, a request message transmitted by the originator 510 may include at least one parameter. Additionally, a parameter may be a mandatory parameter or an optional parameter. For example, a parameter related to a transmission terminal, a parameter related to a receiving terminal, an identification parameter and an operation parameter may be mandatory parameters. In addition, optional parameters may be related to other types of information. In particular, a transmission terminal-related parameter may be a parameter for the originator 510. In addition, a receiving terminal-related parameter may be a parameter for the receiver 520. An identification parameter may be a parameter required for identification of each other.

Further, an operation parameter may be a parameter for distinguishing operations. For example, an operation parameter may be set to any one among Create, Retrieve, Update, Delete and Notify. In other words, the parameter may aim to distinguish operations. In response to receiving a request message from the originator 510, the receiver 520 may be configured to process the message. For example, the receiver 520 may be configured to perform an operation included in a request message. For the operation, the receiver 520 may be configured to determine whether a parameter is valid and authorized. In particular, in response to determining that a parameter is valid and authorized, the receiver 520 may be configured to check whether there is a requested resource and perform processing accordingly.

For example, in case an event occurs, the originator 510 may be configured to transmit a request message including a parameter for notification to the receiver 520. The receiver 520 may be configured to check a parameter for a notification included in a request message and may perform an operation accordingly. The receiver 520 may be configured to transmit a response message to the originator 510.

A message exchange process using a request message and a response message, as illustrated in FIG. 5, may be performed between AE and CSE based on the reference point Mca or between CSEs based on the reference point Mcc. In other words, the originator 510 may be AE or CSE, and the receiver 520 may be AE or CSE. According to an operation in a request message, such a message exchange process as illustrated in FIG. 5 may be initiated by either AE or CSE.

A request from a requestor to a receiver through the reference points Mca and Mcc may include at least one mandatory parameter and at least one optional parameter. In other words, each defined parameter may be either mandatory or optional according to a requested operation. For example, a response message may include at least one parameter among those listed in Table 1 below.

TABLE 1
Response message parameter/success or not

Response Status Code - successful, unsuccessful, ack
Request Identifier - uniquely identifies a Request message
Content - to be transferred
To - the identifier of the Originator or the Transit CSE that sent the
corresponding non-blocking request
From - the identifier of the Receiver
Originating Timestamp - when the message was built
Result Expiration Timestamp - when the message expires
Event Category - what event category shall be used for the response
message
Content Status
Content Offset
Token Request Information
Assigned Token Identifiers
Authorization Signature Request Information
Release Version Indicator - the oneM2M release version that this response
message conforms to

A filter criteria condition, which can be used in a request message or a response message, may be defined as in Table 2 and Table 3 below.

TABLE 2

| | | |
|---|---|---|
| Condition tag | Multiplicity | Description |

Matching Conditions

| | | |
|---|---|---|
| createdBefore | 0 . . . 1 | The creationTime attribute of the matched resource is chronologically before the |
| | | specified value. |
| createdAfter | 0 . . . 1 | The creationTime attribute of the matched resource is chronologically after the |
| | | specified value. |
| modifiedSince | 0 . . . 1 | The lastModifiedTime attribute of the matched resource is chronologically after |
| | | the specified value. |
| unmodifiedSince | 0 . . . 1 | The lastModifiedTime attribute of the matched resource is chronologically |
| | | before the specified value. |
| stateTagSmaller | 0 . . . 1 | The stateTag attribute of the matched resource is smaller than the specified |
| | | value. |
| stateTagBigger | 0 . . . 1 | The stateTag attribute of the matched resource is bigger than the specified value. |
| expireBefore | 0 . . . 1 | The expirationTime attribute of the matched resource is chronologically before |
| | | the specified value. |
| expireAfter | 0 . . . 1 | The expirationTime attribute of the matched resource is chronologically after the |
| | | specified value. |
| labels | 0 . . . 1 | The labels attribute of the matched resource matches the specified value. |
| labelsQuery | 0 . . . 1 | The value is an expression for the filtering of labels attribute of resource when it |
| | | is of key-value pair format. The expression is about the relationship between |
| | | label-key and label-value which may include equal to or not equal to, within or |
| | | not within a specified set etc. For example, label-key equals to label value, or |
| | | label-key within {label-value1, label-value2}. Details are defined in [3] |
| childLabels | 0 . . . 1 | A child of the matched resource has labels attributes matching the specified |
| | | value. The evaluation is the same as for the labels attribute above. Details are |
| | | defined in [3]. |
| parentLabels | 0 . . . 1 | The parent of the matched resource has labels attributes matching the specified |
| | | value. The evaluation is the same as for the labels attribute above. Details are |
| | | defined in [3]. |
| resourceType | 0 . . . n | The resourceType attribute of the matched resource is the same as the specified |
| | | value. It also allows differentiating between normal and announced resources. |
| childResourceType | 0 . . . n | A child of the matched resource has the resourceType attribute the same as the |
| | | specified value. |
| parentResourceType | 0 . . . 1 | The parent of the matched resource has the resourceType attribute the same as |
| | | the specified value. |
| sizeAbove | 0 . . . 1 | The contentSize attribute of the <contentInstance> matched resource is equal to |
| | | or greater than the specified value. |
| sizeBelow | 0 . . . 1 | The contentSize attribute of the <contentInstance> matched resource is smaller |
| | | than the specified value. |
| contentType | 0 . . . n | The contentInfo attribute of the <contentInstance> matched resource matches |
| | | the specified value. |
| attribute | 0 . . . n | This is an attribute of resource types (clause 9.6). Therefore, a real tag name is |
| | | variable and depends on its usage and the value of the attribute can have wild |
| | | card *. E.g. creator of container resource type can be used as a filter criteria tag |
| | | as “creator=Sam”, “creator=Sam*”, “creator=*Sam”. |
| childAttribute | 0 . . . n | A child of the matched resource meets the condition provided. The evaluation of |
| | | this condition is similar to the attribute matching condition above. |
| parentAttribute | 0 . . . n | The parent of the matched resource meets the condition provided. The |
| | | evaluation of this condition is similar to the attribute matching condition above. |
| semanticsFilter | 0 . . . n | Both semantic resource discovery and semantic query use semanticsFilter to |
| | | specify a query statement that shall be specified in the SPARQL query language |
| | | [5]. When a CSE receives a RETRIEVE request including a semanticsFilter, and |
| | | the Semantic Query Indicator parameter is also present in the request, the |
| | | request shall be processed as a semantic query; otherwise, the request shall be |
| | | processed as a semantic resource discovery. |
| | | In the case of semantic resource discovery targeting a specific resource, if the |
| | | semantic description contained in the <semanticDescriptor> of a child resource |
| | | matches the semanticFilter, the URI of this child resource will be included in the |
| | | semantic resource discovery result. |
| | | In the case of semantic query, given a received semantic query request and its |
| | | query scope, the SPARQL query statement shall be executed over aggregated |
| | | semantic information collected from the semantic resource(s) in the query scope |
| | | and the produced output will be the result of this semantic query. |
| | | Examples for matching semantic filters in SPARQL to semantic descriptions can |
| | | be found in [i.28]. |
| filterOperation | 0 . . . 1 | Indicates the logical operation (AND/OR) to be used for different condition tags. |
| | | The default value is logical AND. |
| contentFilterSyntax | 0 . . . 1 | Indicates the Identifier for syntax to be applied for content-based discovery. |
| contentFilterQuery | 0 . . . 1 | The query string shall be specified when contentFilterSyntax parameter is |
| | | present. |

TABLE 3

| | | |
|---|---|---|
| Condition tag | Multiplicity | Description |

Filter Handling Conditions

| | | |
|---|---|---|
| filterUsage | 0 . . . 1 | Indicates how the filter criteria is used. If provided, possible values are |
| | | ‘discovery’ and ‘IPEOnDemandDiscovery’. |
| | | If this parameter is not provided, the Retrieve operation is a generic retrieve |
| | | operation and the content of the child resources fitting the filter criteria is |
| | | returned. |
| | | If filterUsage is ‘discovery’, the Retrieve operation is for resource discovery |
| | | (clause 10.2.6), i.e. only the addresses of the child resources are returned. |
| | | If filterUsage is ‘IPEOnDemandDiscovery’, the other filter conditions are sent to |
| | | the IPE as well as the discovery Originator ID. When the IPE successfully |
| | | generates new resources matching with the conditions, then the resource |
| | | address(es) shall be returned. This value shall only be valid for the Retrieve |
| | | request targeting an <AE> resource that represents the IPE. |
| limit | 0 . . . 1 | The maximum number of resources to be included in the filtering result. This |
| | | may be modified by the Hosting CSE. When it is modified, then the new value |
| | | shall be smaller than the suggested value by the Originator. |
| level | 0 . . . 1 | The maximum level of resource tree that the Hosting CSE shall perform the |
| | | operation starting from the target resource (i.e. To parameter). This shall only be |
| | | applied for Retrieve operation. The level of the target resource itself is zero and |
| | | the level of the direct children of the target is one. |
| offset | 0 . . . 1 | The number of direct child and descendant resources that a Hosting CSE shall |
| | | skip over and not include within a Retrieve response when processing a Retrieve |
| | | request to a targeted resource. |
| applyRelativePath | 0 . . . 1 | This attribute contains a resource tree relative path |
| | | (e.g. . . . /tempContainer/LATEST). This condition applies after all the matching |
| | | conditions have been used (i.e. a matching result has been obtained). The |
| | | attribute determines the set of resource(s) in the final filtering result. The |
| | | filtering result is computed by appending the relative path to the path(s) in the |
| | | matching result. All resources whose Resource-IDs match that combined path(s) |
| | | shall be returned in the filtering result. If the relative path does not represent a |
| | | valid resource, the outcome is the same as if no match was found, i.e. there is no |
| | | corresponding entry in the filtering result. |

A response to a request for accessing a resource through the reference points Mca and Mcc may include at least one mandatory parameter and at least one optional parameter. In other words, each defined parameter may be either mandatory or optional according to a requested operation or a mandatory response code. For example, a request message may include at least one parameter among those listed in Table 4 below.

TABLE 4
Request message parameter

| | |
|---|---|
| Mandatory | Operation - operation to be executed/CREAT, Retrieve, Update, Delete, Notify |
| | To - the address of the target resource on the target CSE |
| | From - the identifier of the message Originator |
| | Request Identifier - uniquely identifies a Request message |
| Operation | Content - to be transferred |
| dependent | Resource Type - of resource to be created |
| Optional | Originating Timestamp - when the message was built |
| | Request Expiration Timestamp - when the request message expires |
| | Result Expiration Timestamp - when the result message expires |
| | Operational Execution Time - the time when the specified operation is to be executed by the target CSE |
| | Response Type - type of response that shall be sent to the Originator |
| | Result Persistence - the duration for which the reference containing the responses is to persist |
| | Result Content - the expected components of the result |
| | Event Category - indicates how and when the system should deliver the message |
| | Delivery Aggregation - aggregation of requests to the same target CSE is to be used |
| | Group Request Identifier - Identifier added to the group request that is to be fanned out to each member |
| | of the group |
| | Group Request Target Members-indicates subset of members of a group |
| | Filter Criteria - conditions for filtered retrieve operation |
| | Desired Identifier Result Type - format of resource identifiers returned |
| | Token Request Indicator - indicating that the Originator may attempt Token Request procedure (for |
| | Dynamic Authorization) if initiated by the Receiver |
| | Tokens - for use in dynamic authorization |
| | Token IDs - for use in dynamic authorization |
| | Role IDs - for use in role based access control |
| | Local Token IDs - for use in dynamic authorization |
| | Authorization Signature Indicator - for use in Authorization Relationship Mapping |
| | Authorization Signature - for use in Authorization Relationship Mapping |
| | Authorization Relationship Indicator - for use in Authorization Relationship Mapping |
| | Semantic Query Indicator - for use in semantic queries |
| | Release Version Indicator - the oneM2M release version that this request message conforms to. |
| | Vendor Information |

A normal resource includes a complete set of representations of data constituting the base of information to be managed. Unless qualified as either “virtual” or “announced”, the resource types in the present document are normal resources. A virtual resource is used to trigger processing and/or a retrieve result. However, a virtual resource does not have a permanent representation in a CSE. An announced resource contains a set of attributes of an original resource. When an original resource changes, an announced resource is automatically updated by the hosting CSE of the original resource. The announced resource contains a link to the original resource. Resource announcement enables resource discovery. An announced resource at a remote CSE may be used to create a child resource at a remote CSE, which is not present as a child of an original resource or is not an announced child thereof.

To support resource announcement, an additional column in a resource template may specify attributes to be announced for inclusion in an associated announced resource type. For each announced <resourceType>, the addition of suffix “Annc” to the original <resourceType> may be used to indicate its associated announced resource type. For example, resource <containerAnnc> may indicate the announced resource type for <container> resource, and <groupAnnc> may indicate the announced resource type for <group> resource.

The present disclosure relates to a method and device for generating a measurement of a vanishing sensor in an M2M system. Herein, the vanishing sensor may be a disposable sensor that disappears after fulfilling the role of vanishing sensor. For example, a system for measuring a temperature of exhaust gas of a jet engine may exist for determining efficiency of the engine. Herein, a vanishing sensor may be installed in an exhaust path where the highest heat of the jet engine is discharged. Accordingly, the vanishing sensor may vanishes due to high heat or high pressure after measuring temperature for a long time. That is, the vanishing sensor may be burned out by high heat. After the vanishing sensor vanishes, the temperature of the exhaust path may be measured through another sensor (hereinafter referred to as ‘first sensor’) in a safe place near the engine. Herein, the safe place may be a place adjacent to the engine and beyond the reach of heat. In addition, the first sensor may be one and more sensors. Herein, the first sensor may refer to data that are measured before the vanishing sensor is burned out by high heat. High heat inside the engine may be measured using a mathematical correlation between a last measurement of the vanishing sensor and a measurement measured in the safe place. Through such a process, a sensor may be virtually recreated in the exhaust path after the vanishing sensor vanishes. Hereinafter will be described a method for generating a measurement of a vanishing sensor according to the present disclosure.

According to the present disclosure, a vanishing sensor may have two different status. One status of the two different status may be a status where the vanishing sensor physically exists (hereinafter referred to as ‘first status’), that is, a status where the vanishing sensor has not vanished yet. The other status may be a status where the vanishing sensor has vanished (hereinafter referred to as ‘second status’). When the vanishing sensor has the first status, the vanishing sensor may measure a measurement on its own. On the other hand, when the vanishing sensor has the second status, the vanishing sensor may measure a measurement by using a reference sensor.

According to the present disclosure, an Internet of Things (IoT) platform or a cloud IoT platform may manage data that are measured by reference sensors adjacent to a vanishing sensor. The IoT platform may perceive a relationship between the vanishing sensor and the reference sensors adjacent thereto. In addition, the IoT platform may generate a measurement of the vanishing sensor through a preconfigured equation even when the vanishing sensor has vanished.

According to the present disclosure, an IoT platform may behave differently depending on the status of a vanishing sensor. When the vanishing sensor has the first status, all measurements may be stored in the platform based on a real measurement (hereinafter referred to as ‘first measurement’) measured by the vanishing sensor. On the other hand, when the vanishing sensor has the second status, a measurement measured from an adjacent sensor (hereinafter referred to as ‘second measurement’) may be referenced for the vanishing sensor that has vanished. Accordingly, the platform may store a result value that is obtained by applying the second measurement to a mathematical equation.

An IoT platform according to the present disclosure may have information on a sensor type, a reference sensor, a mathematical equation, a vanished time, a measurement cycle, and the like. Herein, the sensor type may be information regarding whether or not a sensor is a vanishing sensor. In addition, a reference sensor may be a sensor that is referenced after a vanishing sensor vanishes. The equation may be a mathematical equation for generating a measurement for a vanishing sensor after the vanishing sensor vanishes. The vanished time may be information on a time when a vanishing sensor vanishes. The measurement cycle may be the number of times or a cycle in which a vanishing sensor generates a measurement. Hereinafter, the present disclosure proposes a resource <vanishingSensor> to support the concept of a vanishing sensor with a new resource.

FIG. 6 illustrates a measurement mechanism of a vanishing sensor in an M2M system according to an embodiment of the present disclosure. Referring to FIG. 6, there may be a sensor-A 610 and a sensor-B 620. Herein, the sensor-A 610 may be a vanishing sensor, and the sensor-B 620 may be a reference sensor. When the sensor-A 610 vanishes, the sensor-B 620 may be configured as a reference sensor of the sensor-A 610. Before the sensor-A 610 vanishes, measurements of the sensor-A 610, that is, A1, A2, A3, A4 and A5 may be used as they are. However, after the sensor-A 610 vanishes, the sensor-A 610 cannot generate a measurement any more. Accordingly, based on measurements B6, B7, B8, B9 and B10 generated from an adjacent sensor like the sensor-B 620, measurements A6, A7, A8, A9 and A10 of the sensor-A 610 may be generated. Herein, in order to generate the measurements of the sensor-A 610, a preconfigured equation may be applied to a measurement of the sensor-B 620. For example, if the measurement of the sensor-B 620 is 100 and the preconfigured equation is “multiply 2”, a value generated for the sensor-A 610 may be 200.

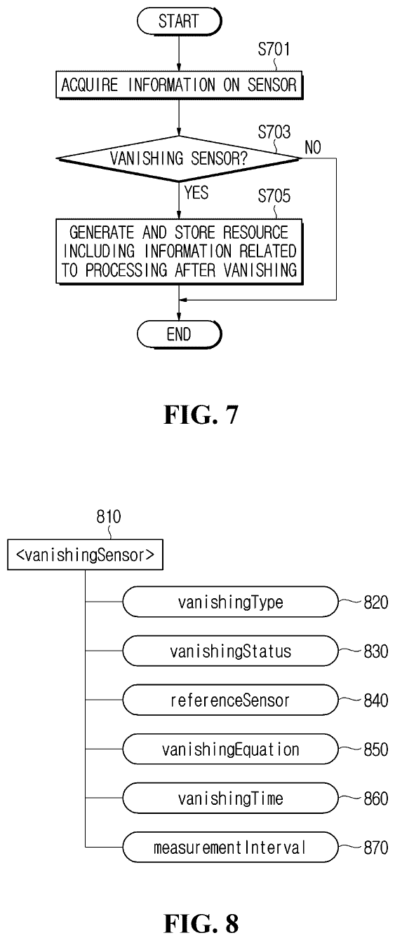

FIG. 7 illustrates an example of a procedure for acquiring sensor information in an M2M system according to an embodiment of the present disclosure. An operating agent of FIG. 7 may be a device (e.g. CSE) for managing a resource. In the description below, the operating agent of FIG. 7 will be referred to as ‘device’.

Referring to FIG. 7, at step S701, a device may acquire information on a sensor. For example, the information on the sensor may include information on the type of the sensor, the ability of the sensor, and the like. Herein, the sensor may be a newly installed sensor that is not registered to an IoT network managed by the device. In this case, according to an embodiment, the device may receive the information through a registration procedure for the new sensor. Alternatively, the sensor may be a sensor that is already registered. In this case, according to another embodiment, the device may receive the information through a resource update procedure for the sensor or a separate offline procedure.

At step S703, the device may check whether or not the sensor is a vanishing sensor. That is, at step S701, the device may check, by using the information acquired at step S701, whether or not the sensor is a vanishing sensor. If the sensor is a vanishing sensor, the device may perform step S705. However, if the sensor is not a vanishing sensor, the device may end this procedure.

At step S705, the device may generate and store a resource including information related to processing after vanishing. According to an embodiment, if there is already a resource for the sensor, the device may not generate a new resource but add information related to processing after vanishing to the resource that already exists. According to another embodiment, even if there is already a resource for the sensor, the device may additionally generate a new resource. Herein, information related to processing after vanishing may include information related to at least one of a current status of the sensor, a handling method for the sensor that has vanished, and a method for replacing the function of the sensor that has vanished. Accordingly, even when the sensor has vanished, the device may smoothly operate and manage an IoT network.

FIG. 8 illustrates a resource of a vanishing sensor in an M2M system according to an embodiment of the present disclosure. Herein, the resource of the vanishing sensor may be information necessary for the vanishing sensor. The resource of the vanishing sensor, that is, a resource <vanishingSensor> 810 includes a plurality of sub-resources or attributes associated with the vanishing sensor. For example, the plurality of sub-resources or attributes may include vanishingType 820, vanishingStatus 830, referenceSensor 840, vanishingEquation 850, vanishedTime 860, and measurementInterval 870. vanishingType 820 indicates whether or not a sensor is a vanishing sensor. In addition, vanishingStatus 830 indicates whether or not a sensor is in a vanished status. In addition, referenceSensor 840 indicates a reference sensor after a vanishing sensor vanishes. Herein, referenceSensor 840 may include a uniform resource identifier (URI) of the sensor. In addition, vanishingEquation 850 may include a rule for generating a measurement for a vanishing sensor. For example, in case a vanishing sensor and a reference sensor are in a simple addition relationship, the attribute may have a ‘plus operation’ value. In addition, vanishedTime 860 may indicate when a vanishing sensor vanishes. That is, vanishedTime 860 may indicate a vanished time of a vanishing sensor. In addition, measurementInterval 870 indicates a time interval at which a vanishing sensor generates a value. vanishedTime 860 may include information on a cycle or the number of times a vanishing sensor generates a value.

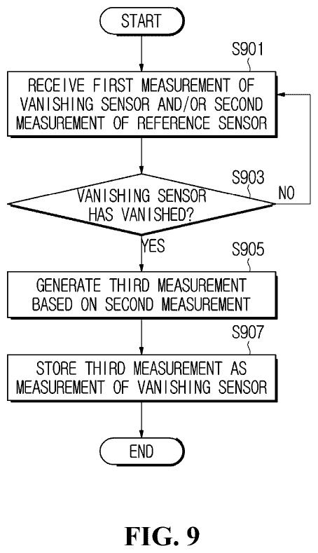

FIG. 9 illustrates an example of a procedure for generating a measurement of a vanishing sensor in an M2M system according to an embodiment of the present disclosure. An operating agent of FIG. 9 may be a device (e.g. CSE) for managing a resource. In the description below, the operating agent of FIG. 9 will be referred to as ‘device’.

Referring to FIG. 9, at step S901, a device may receive a measurement of a vanishing sensor (hereinafter referred to as ‘first measurement’) and/or a measurement of a reference sensor (hereinafter referred to as ‘second measurement’). Herein, when the reference sensor for the vanishing sensor generates a new measurement, the device may store the new measurement measured by the reference sensor. In addition, the device may periodically receive the first measurement and/or the second measurement.

At step S903, the device may check whether or not the vanishing sensor has vanished. That is, the device may check a status of the vanishing sensor. Herein, the status of the vanishing sensor may be classified into a status of physical existence (e.g., non-vanished status), a status of having physically vanished but still capable of generating a value (e.g. Vanished status), and a permanently vanished status. Herein, in order to check a status of the vanishing sensor, the device may use a cycle. For example, in case a measurement of the vanishing sensor to be periodically received is not received, the device may determine that the status of the vanishing sensor is in a vanished status. If the status of the vanishing sensor is not in the vanished status but the vanishing sensor generates a new measurement, the system returns to step S901. On the other hand, if the vanishing sensor is in the vanished status, the system proceeds to step S905.

At step S905, the device may generate a third measurement based on the second measurement. As an example, the device may generate the third measurement by applying a predefined function to the second measurement. Herein, the predefined function may be a formula or equation that is defined beforehand in the device. Accordingly, the device may generate a measurement for the vanishing sensor (hereinafter referred to as ‘third measurement’) by applying the predefined formula to the second measurement. Herein, the predefined equation may also be referred to as a vanishing equation.

At step S907, the device may store the third measurement as a measurement of the vanishing sensor. That is, the device may store a measurement, which is generated by applying a vanishing equation, a new measurement for the vanishing sensor.

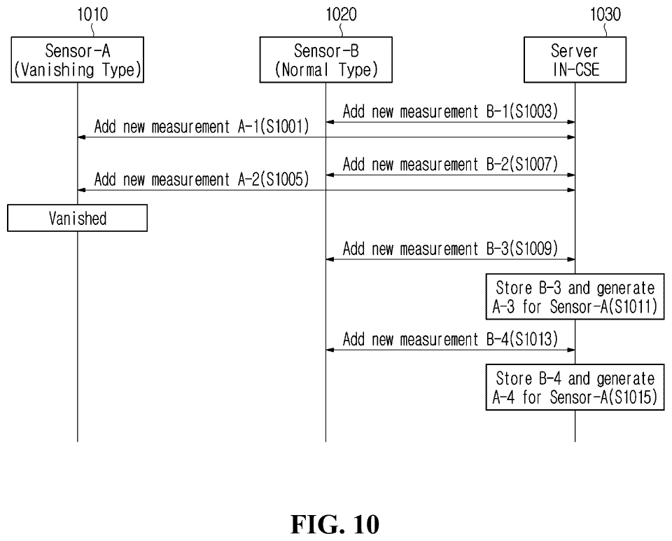

FIG. 10 illustrates an example of a procedure for generating a measurement of a vanishing sensor in an M2M system according to the present disclosure. FIG. 10 exemplifies signal exchange among a sensor-A 1010, a sensor-B 1020, and a server IN-CSE 1030. Herein, the sensor-A 1010 may be a vanishing sensor, and the sensor-B 1020 may be a reference sensor.

Referring to FIG. 10, at step S1001, the sensor-A 1010 may generate a new measurement A-1 and transmit the new measurement A-1 to the server IN-CSE 1030. Herein, the server IN-CSE 1030 may store the measurement A-1 received from the sensor-A 1010. In addition, the sensor-A 1010 may also receive a measurement from the server IN-CSE 1030.

At step S1003, the sensor-B 1020 may generate a new measurement B-1 and transmit the new measurement B-1 to the server IN-CSE 1030. Herein, the server IN-CSE 1030 may store the measurement B-1 received from the sensor-B 1020. In addition, the sensor-B 1020 may also receive a measurement from the server IN-CSE 1030. Next, the server IN-CSE 1030 may check whether or not a vanishing sensor has vanished. If the vanishing sensor has not vanished, step S1001 and step S1003 may be repeated. Herein, step S1101 and step S1003 may be periodically repeated, and the present disclosure is not limited thereto.

At step S1005, the sensor-A 1010 may generate a new measurement A-2 and transmit the new measurement A-2 to the server IN-CSE 1030. Herein, the server IN-CSE 1030 may store the measurement A-2 received from the sensor-A 1010. In addition, the sensor-A 1010 may also receive a measurement from the server IN-CSE 1030.

At step S1007, the sensor-B 1020 may generate a new measurement B-2 and transmit the new measurement B-2 to the server IN-CSE 1030. Herein, the server IN-CSE 1030 may store the measurement B-2 received from the sensor-B 1020. In addition, the sensor-B 1020 may also receive a measurement from the server IN-CSE 1030. Next, the server IN-CSE 1030 may check again whether or not the vanishing sensor has vanished. If the vanishing sensor has vanished, step S1009 may be performed. Herein, whether or not the vanishing sensor has vanished may be checked using a cycle. For example, if a measurement of the vanishing sensor, which has been periodically received, the device may determine that the vanishing sensor has vanished.

At step S1009, the sensor-B 1020 may generate a new measurement B-3 and transmit the new measurement B-3 to the server IN-CSE 1030. In addition, the sensor-B 1020 may also receive a measurement from the server IN-CSE 1030.

At step S1011, the server IN-CSE 1030 may store the measurement B-3 received from the sensor-B 1020. In addition, the server IN-CSE 1030 may generate and store a measurement A-3 for the sensor-A 1010. Herein, the measurement A-3 for the sensor-A 1010 may be generated by applying a formula to the measurement B-3 that is measured by the sensor-B 1020.

At step S1013, the sensor-B 1020 may generate a new measurement B-4 again and transmit the new measurement B-4 to the server IN-CSE 1030. In addition, the sensor-B 1020 may also receive a measurement from the server IN-CSE 1030.

At step S1015, the server IN-CSE 1030 may store the measurement B-4 received from the sensor-B 1020. In addition, the server IN-CSE 1030 may generate and store a measurement A-4 for the sensor-A 1010. Herein, the measurement A-4 for the sensor-A 1010 may be generated by applying a formula to the measurement B-4 that is measured by the sensor-B 1020. Herein, the formula applied to the measurement B-4 may be the same as the formula applied at step S1011 or be different therefrom. After the vanishing sensor vanishes, steps S1009 to S1015 may be repeatedly performed.

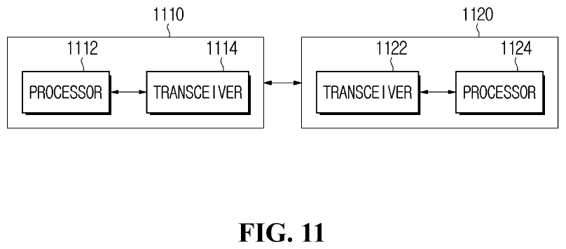

FIG. 11 illustrates a configuration of an M2M device in an M2M system according to the present disclosure. An M2M device 1110 or an M2M device 1120 illustrated in FIG. 11 may be understood as hardware functioning as at least one among the above-described AE, CSE and NSE.

Referring to FIG. 11, the M2M device 1110 may include a processor 1112 controlling a device and a transceiver 1114 transmitting and receiving a signal. Herein, the processor 1112 may control the transceiver 1114. In addition, the M2M device 1110 may communicate with another M2M device 1120. The another M2M device 1120 may also include a processor 1122 and a transceiver 1124, and the processor 1122 and the transceiver 1124 may perform the same function as the processor 1112 and the transceiver 1114.

As an example, the originator, the receiver, AE and CSE, which are described above, may be one of the M2M devices 1110 and 1120 of FIG. 11, respectively. In addition, the devices 1110 and 1120 of FIG. 11 may be other devices. As an example, the devices 1110 and 1120 of FIG. 11 may be communication devices, vehicles, or base stations. That is, the devices 1110 and 1120 of FIG. 11 refer to devices capable of performing communication and are not limited to the above-described embodiment.

The above-described exemplary embodiments of the present disclosure may be implemented by various means. For example, the exemplary embodiments of the present disclosure may be implemented by hardware, firmware, software, or a combination thereof.

The foregoing description of the exemplary embodiments of the present disclosure has been presented for those skilled in the art to implement and perform the disclosure. While the foregoing description has been presented with reference to the preferred embodiments of the present disclosure, it will be apparent to those skilled in the art that various modifications and variations can be made in the present disclosure without departing from the spirit or scope of the present disclosure as defined by the following claims.

Accordingly, the present disclosure is not intended to be limited to the exemplary embodiments shown herein but is to be accorded the widest scope consistent with the principles and novel features disclosed herein. In addition, while the exemplary embodiments of the present specification have been particularly shown and described, it is to be understood that the present specification is not limited to the above-described exemplary embodiments, but, on the contrary, it will be understood by those skilled in the art that various changes and modifications may be made without departing from the spirit and scope of the present specification as defined by the claims below, and such changes and modifications should not be individually understood from the technical thought and outlook of the present specification.

In this specification, both the disclosure and the method disclosure are explained, and the description of both disclosures may be supplemented as necessary. In addition, the present disclosure has been described with reference to exemplary embodiments thereof. It will be understood by those skilled in the art that various changes in form and details may be made therein without departing from the essential characteristics of the present disclosure. Therefore, the disclosed exemplary embodiments should be considered in an illustrative sense rather than in a restrictive sense. The scope of the present disclosure is defined by the appended claims rather than by the foregoing description, and all differences within the scope of equivalents thereof should be construed as being included in the present disclosure.

1. A method for operating a device managing a sensor in a machine-to-machine (M2M) system, the method comprising:
receiving at least one of a first measurement of a vanishing sensor or a second measurement of a reference sensor;
determining whether or not the vanishing sensor has vanished;
generating a third measurement based on the second measurement in case the vanishing sensor is determined to have vanished; and
storing the third measurement as a measurement of the vanishing sensor that has vanished.

2. The method of claim 1, wherein at least one of the first measurement or the second measurement is received the measurement periodically.

3. The method of claim 1, wherein whether or not the vanishing sensor has vanished is determined based on whether or not a measurement of the vanishing sensor is received.

4. The method of claim 1, further comprising:
acquiring information on a new sensor;
determining whether or not the new sensor is a vanishing sensor;
generating a resource including information related to processing after vanishing; and
storing the resource.

5. The method of claim 4, wherein the resource includes at least one of first information indicating whether or not the new sensor is a vanishing sensor, second information indicating whether or not the vanishing sensor has vanished, third information indicating information on a reference sensor that is to be referenced after the vanishing sensor has vanished, fourth information indicating information on a formula to be applied to a measurement of the reference sensor, fifth information indicating information on time of vanishing of the vanishing sensor, or sixth information indicating information on an interval at which the vanishing sensor generates a measurement.

6. The method of claim 5, wherein the fourth information includes information on a uniform resource identifier (URI) of the reference sensor.

7. The method of claim 5, wherein the sixth information includes at least one of a cycle or the number of times the vanishing sensor generates a measurement.

8. A device for managing a sensor in a machine-to-machine (M2M) system, the device comprising:
a transceiver; and
a processor coupled with the transceiver,
wherein the processor is configured to:
receive at least one of a first measurement of a vanishing sensor or a second measurement of a reference sensor,
determine whether or not the vanishing sensor has vanished,
generate a third measurement based on the second measurement in case the vanishing sensor is determined to have vanished, and
store the third measurement as a measurement of the vanishing sensor that has vanished.

9. The device of claim 8, wherein the measurement of at least one of the vanishing sensor or the reference sensor is periodically received.

10. The device of claim 8, wherein whether or not the vanishing sensor has vanished is determined based on whether or not a measurement of the vanishing sensor is received.

11. The device of claim 8, wherein the processor is further configured to:
acquire information on a new sensor,
determine whether or not the new sensor is a vanishing sensor, and
generate a resource including information related to processing after vanishing, and
store the resource.

12. The device of claim 11, wherein the resource includes at least one of first information indicating whether or not the new sensor is a vanishing sensor, second information indicating whether or not the vanishing sensor has vanished, third information indicating information on a reference sensor that is to be referenced after the vanishing sensor has vanished, fourth information indicating information on a formula to be applied to a measurement of the reference sensor, fifth information indicating information on time of vanishing of the vanishing sensor, or sixth information indicating information on an interval at which the vanishing sensor generates a measurement.

13. The device of claim 12, wherein the fourth information includes information on a uniform resource identifier (URI) of the reference sensor.

14. The device of claim 12, wherein the sixth information includes at least one of a cycle or the number of times the vanishing sensor generates a measurement.
